(19) United States
(12) Patent Application Publication
(10) Pub. No.: US 2015/0039494 A1
(43) Pub. Date: Feb. 5, 2015

(54) PAIRED WEARABLE PAYMENT DEVICE

(71) Applicant: MasterCard International Incorporated, Purchase, NY (US)

(72) Inventors: James D. Sinton, Leigh-on-Sea (GB); Hemel Sanghvi, St. Charles, MO (US); Colin Tanner, Middlesex (GB)

(21) Appl. No.: 14/322,409

(22) Filed: Jul. 2, 2014

(30) Foreign Application Priority Data
Aug. 1, 2013 (GB) 1313805.2

(51) Int. Cl. G06Q 20/32

(52) U.S. Cl. CPC G06Q 20/327
USPC 705/39

(57) ABSTRACT

The present invention relates to an electronic device 101 for use in a transaction process. The electronic device 101 comprises a first wireless communication module for communicating with a second electronic device 102 and a second wireless communication module for communicating with a payment terminal 106 for the purpose of performing a payment transaction. The electronic device 101 is capable of relaying data between the second device 102 and the payment terminal 106. A method of performing a transaction is also disclosed, said method comprising the following steps. Firstly, a first wireless communication between an electronic device 101 and a second electronic device 102 is established. Secondly, transaction details required to perform a contactless transaction are uploaded from the second electronic device 102 to the electronic device 101 and securely stored on the electronic device 101. Thirdly a second wireless communication between the electronic device 101 and a payment terminal 106 is established. Finally, the payment terminal 106 is provided with the transaction details.

### CROSS-REFERENCE TO RELATED APPLICATION

This application is a U.S. National Stage filing under 35 U.S.C. §119, based on and claiming benefit of and priority to GB Patent Application No. 1313805.2 filed Aug. 1, 2013, the entire contents of which are hereby incorporated in their entirety for all purposes.

### FIELD OF THE INVENTION

The present invention relates generally, but not exclusively, to a device for performing contactless transactions which provides the user with enhanced functionality, security and convenience.

### BACKGROUND TO THE INVENTION

PayPass™ provides an EMV™ compatible, contactless payment feature. Based on the ISO/IEC 14443 standard, it provides users with a simple, convenient way to perform transactions by tapping a payment card on a point-of-sale (POS) terminal, which comprises an appropriate reader, rather than swiping or inserting a payment card as has been done traditionally.

Typical PayPass-enabled payment cards comprise a chip, which may be the same as or similar to the chip or secure element present in a regular chip and PIN card, and an antenna connected to the chip. Payment details can be transmitted securely and wirelessly from the chip to a POS terminal by means of the antenna.

In a typical contactless transaction, an electronic cash register sends details of a transaction to a PayPass™ or similarly enabled POS terminal. A PayPass-enabled payment card is placed or tapped against the POS terminal. The terminal activates and recognises the payment card which then securely transmits payment account details to the terminal. The account and transaction details are then processed by the same payment processing network used for regular transactions. The MasterCard™ operated Banknet™ is one such network. Confirmation of the completion of a transaction may be provided within a fraction of a second after the payment card has been placed or tapped against the POS terminal.

Banknet™ is one of the world's largest global telecommunications networks which links all MasterCard™ members and MasterCard™ data processing centres into a single financial network. Banknet™ facilitates the routing of transactions for authorisation from almost anywhere in the world. Typically, payment networks such as Banknet™ comply with standards specifications which define the interchange message specifications for the exchange of electronic transactions made by cardholders using payment cards. ISO 8583—Financial transaction card originated messages—is one such standard.

For security reasons there is typically a payment limit on single contactless transactions (for example £20 in the UK). Where transactions exceed such a limit, a PIN may be requested. Also, typically, contactless cards can only be used a certain number of times before customers are asked for their PIN. Where a PIN is required it may be input via the terminal as with regular chip and PIN transactions.

More recently, MasterCard PayPass™ functionality has been developed for use with mobile phones. MasterCard Mobile PayPass™ makes use of near field communication (NFC) channels to enable mobile phones fitted with an NFC transceiver or transmitter (henceforth NFC mobile phones) to act as payment devices. MasterCard Mobile PayPass™ enables wireless transactions to be made by placing or tapping a MasterCard Mobile PayPass™ enabled NFC mobile phone against a PayPass™ enabled POS terminal.

Mobile phones used as payment devices are usually required to comprise a secure element (SE) or be equivalently capable of providing for the secure hosting of applications and their confidential and cryptographic data. These requirements must be met in accordance with the rules and security requirements set forth by a set of well-identified trusted authorities such as the standard set by EMV™.

The SE may comprise part of a mobile phone's Universal Integrated Circuit Card (UICC) upon which a PayPass™ Payment Application and a subscriber identity module (SIM) application and/or Universal Mobile Telecommunications System (UMTS) application may reside. The SE may be embedded separately within the mobile phone or the SE may reside on a MicroSD™, or any other removable storage medium suitable for use with a mobile phone upon which a PayPass™ Payment Application resides.

The user of an NFC mobile phone can download an application to their phone which in turn allows payment card details to be downloaded onto the phone. An example application is the MasterCard Mobile PayPass™ application. An advantage of such a system over a regular payment card is that the applications stored on the SE may be remotely modified and also benefit from access to the phone's user interface.

The transaction process for MasterCard Mobile PayPass™ transactions mirrors that of a PayPass™ payment card transaction. An electronic cash register sends details of a transaction to a PayPass™ or similarly enabled POS terminal. The appropriately configured mobile phone is placed or tapped against the terminal. The terminal activates and establishes communications with the NFC circuitry in the mobile phone which then securely transmits payment account details to the terminal. The account and transaction details are then processed conventionally, through a payment processing network.

Additionally, where a PIN is required, for example, when a transaction is above a pre-determined threshold, for example of £20, the PIN may be input via the mobile phone's user interface (UI). This step may be performed in advance of the mobile phone being placed or tapped against the POS terminal in anticipation of a PIN requirement. Alternatively, the PIN entry step may be performed on request: following the first placement or tap, a PIN may be requested and subsequently entered using the mobile phone's UI, with the mobile phone once being more placed or tapped against the POS terminal to complete the transaction.

As has been previously indicated, a mobile phone must currently be NFC enabled in order to perform a MasterCard Mobile PayPass™ or a similarly contactless transaction. The majority of mobile phones currently in use are not NFC enabled. However, many of these phones have the requisite hardware and software required to run payment applications such as the Mobile PayPass™ Payment Application.

Currently, a person wishing to make a transaction is required to take their mobile phone out of their pocket or bag in order to perform said transaction.

### SUMMARY OF INVENTION

In accordance with a first aspect of the present invention, an electronic device for use in a transaction process is provided, the electronic device comprising: a first wireless communication module for communicating with a second electronic device; a second wireless communication module for communicating with a payment terminal; and, wherein the electronic device is capable of relaying data between the second electronic device and the payment terminal.

Preferably, the first wireless communication module comprises one of an NFC or RFID transmitter or transceiver and the second wireless communication module comprises one of a Bluetooth, infra-red Wireless, Induction Wireless, second NFC, WLAN or Ultra Wideband transmitter or transceiver.

Preferably, the electronic device is configured to wirelessly communicate with the second electronic device via the Bluetooth transmitter or transceiver and is further configured to wirelessly communicate with the payment terminal via the NFC or RFID transmitter or receiver.

Preferably, a Bluetooth connection with the second electronic device is a secure, private communications link.

Preferably, the electronic device comprises at least part of a wearable device such as a wristwatch, pendant or bracelet.

Preferably, the second electronic device is a mobile phone arranged to be in communication with a remote server via a mobile network or Wi-Fi connection.

Preferably, the mobile phone is in communication with an issuer server via the mobile network.

Preferably, the electronic device further comprises a user interface.

In accordance with a second aspect of the present invention, a transaction processing system is provided, the transaction processing system comprising: an electronic device according to the first aspect; a payment terminal; and a second electronic device, wherein the electronic device is in communication with the payment terminal and the second electronic device, and facilitates the transfer of data between the payment terminal and the second electronic device.

Preferably, the transaction processing system further comprises a communications network and an issuer server, wherein the second electronic device is in communication with the issuer server via the communications network.

Preferably, the second electronic device is a mobile phone and the communications network is a mobile network.

In accordance with a third aspect of the present invention, a method of performing a transaction is provided, said method comprising the steps of: establishing a first wireless communication between an electronic device and a second electronic device; uploading transaction details required to perform a contactless transaction from the second electronic device to the electronic device and securely storing them on the electronic device; establishing a second wireless communication between the electronic device and a payment terminal; and providing the payment terminal with the transaction details.

Preferably, the step of establishing a first wireless communication between the electronic device and the second electronic device comprises establishing a secure, private communications link.

Preferably, the private communications link is one of a Bluetooth, infra-red Wireless, Induction Wireless, NFC, WLAN or Ultra Wideband connection.

Preferably, the transaction details comprise payment card details.

Preferably, the step of establishing a second wireless communication between the electronic device and the payment terminal comprises establishing an NFC or RFID connection.

Preferably, the payment processing network terminal can only be provided with the transaction details when the electronic device is located within a predetermined distance of the second electronic device

In accordance with a fourth aspect of the present invention, there is provided an electronic device according to the first aspect, further comprising: a processor; and a memory in communication with the processor and storing program instructions configured to perform the method according to the third aspect.

### BRIEF DESCRIPTION OF DRAWINGS

Embodiments of the present invention will now be described, by way of example only, with reference to the accompanying drawings, in which:

FIG. 1 depicts the parties, networks and devices involved in a transaction process according the present invention;

FIG. 2 is a flow diagram showing the processes which occur when personalising the electronic device of the present invention;

FIG. 3 is a flow diagram showing the processes which occur during a transaction performed using the electronic device of the present invention;

FIG. 4 is a flow diagram showing the processes which occur during an issuer initiated update of the card information stored on the electronic device of the present invention;

FIG. 5 is a flow diagram showing the processes which typically occur when setting a limit for the number transactions which the electronic device can perform without an established communications link with a mobile phone;

FIG. 6 is a flow diagram showing the processes involved when a PIN is required in advance of an issuer script containing the counter reset data being sent to the mobile phone by an issuer;

FIG. 7 is a flow diagram showing the processes involved where a PIN is required after an issuer script containing the counter reset data is sent to the mobile phone by an issuer.

### DETAILED DESCRIPTION

Contactless (wireless) payment devices are well known. Contactless payment cards are widely used and there are significant developments being made in the field of contactless NFC mobile phone payments.

Barclays™ currently provides its customers with NFC payment sticker tags. These tags are a copy of a cardholder's existing card's SE and are designed to be attached to the cardholder's mobile phone. However, these tags do not communicate in any way with the mobile phone to which they are attached and functionally are the same as a regular contactless payment card. Such tags have been known to be included in a variety of products from key fobs to wristwatches.

Devices which can communicate with mobile phones to add additional functionality are also well known. Bluetooth headsets which pair with a mobile phone and allow the user to accept and conduct calls remotely of a mobile phone are widely available.

The present invention provides an electronic device which can communicate or pair with a mobile phone wirelessly via a Bluetooth™ or other short-range connection, such that data can be transferred between the electronic device and the mobile phone.

The connection between the electronic device and the mobile phone need not necessarily be a Bluetooth™ connection. The connection may be any suitable connection including but not limiting to infra-red Wireless, Induction Wireless, a second NFC connection, WLAN or Ultra Wideband connections.

The electronic device is also radio-frequency identification (RFID) enabled, such that it is able to transmit information to other RFID-enabled devices, such as, a PayPass™ enabled POS terminal.

Alternatively or additionally, the electronic device may be NFC-enabled and may communicate with other NFC-enabled devices, such as, an NFC-enabled POS terminal or the mobile phone where the mobile phone is also NFC-enabled. NFC is an active standard that has its own power source and follows ISO standard 18092. The standard applicable to passive RFID is ISO 14443.

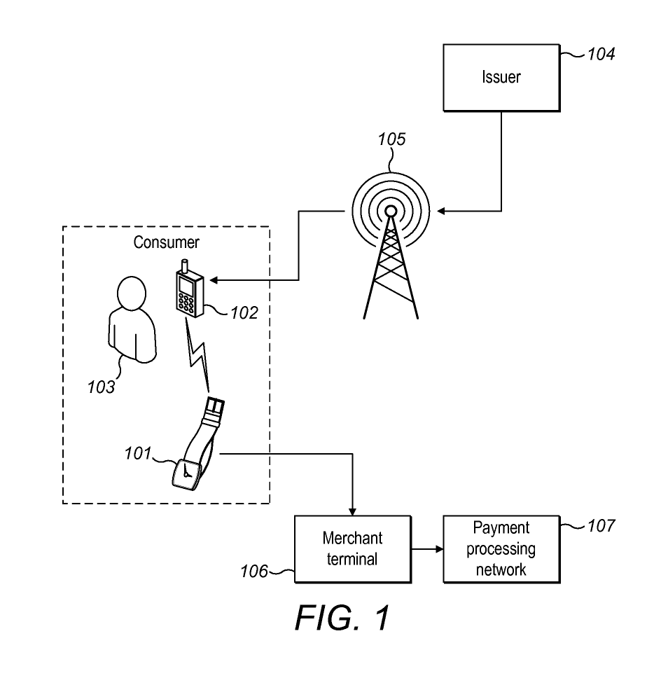

FIG. 1 depicts an electronic device 101 in communication with a mobile phone 102 and a user 103. The mobile phone 102 is in communication with an issuer 104 via a mobile network 105. The electronic device 101 is in communication with a merchant terminal 106 via the above mentioned RFID or NFC connection. The terminal is connected in a conventional manner to a payment processing network 107.

The electronic device 101 is suitable for use with contactless payment platforms such as MasterCard's PayPass™ platform. The electronic device 101 may be capable of storing a PayPass™ Payment Application, such that it may retain and transmit the data required to perform transactions. The data may be stored on a Secure Element comprising part of the electronic device 101 such that the electronic device 101 is capable of performing transactions.

In one embodiment, the electronic device 101 may itself include an SE. The electronic device 101 is thus able to act as a payment device and perform transactions independently of a mobile phone 102. The electronic device 101 can be controlled and managed by the mobile phone 102, as if its SE were an SE within the mobile phone 102, via a pairing of the mobile phone 102 and electronic device 101. As such, the updating of card details and resetting of transaction counters may be affected via the pairing, but the electronic device 101 need not necessarily be paired to the mobile phone 102 in order to perform a transaction.

In another embodiment, the electronic device 101 may not include an SE, but instead may act as a means of providing proxy access to an SE located, for example, in a mobile phone 102. All data communicated between the electronic device 101 and the merchant terminal 106 is forwarded to the mobile phone 102 via a pairing and the transaction is undertaken by means of the SE on the mobile phone 102. The electric device 101 acts as a bridge to the mobile phone's SE.

In all embodiments, the mobile phone 102 with which the electronic device 101 is in communication can be used to upload the data required to perform transactions to the electronic device 101. For example, an application may be downloaded to the mobile phone 102 which facilitates paring of the electronic device 101 with the mobile phone 102 and controls any subsequent exchanges of data between the two devices, e.g. account and payment card information.

The electronic device 101 is capable of providing the paired mobile phone 102 with RFID or NFC functionality. The majority of mobile phones currently in use (including smartphones) are not RFID or NFC-enabled, however, many phones are provided with Bluetooth functionality. As such, the present invention provides a simple way of retrospectively providing such mobile phones with RFID or NFC functionality.

The electronic device 101 may be configured such that the functionality of the electronic device 101 is restricted when not located near the mobile phone 102. Near may be defined as being located within a specified, predetermined distance from the mobile phone 102. The functionality of the electronic device 101 may, for example, be restricted such that it can no longer be used to perform transactions if out of range of the mobile phone 102, for example, when the electronic device 101 is out of range of the short-range pairing.

Such functionality provides significant security advantages. If a user's payment device 101 were to be stolen, it could not be used for performing fraudulent transactions unless the fraudulent user also had possession of the associated mobile phone 102 or remained near to the mobile phone 102.

Such functionality may be implemented by restricting the operation of the electronic device 101 when outside the connectivity range of the connection between the electronic device 101 and the mobile phone 102. For example, the functionality of the electronic device 101 may be restricted unless a connection between the electronic device 101 and the mobile phone 102 is established, i.e. unless the electronic device 101 and mobile phone 102 are in range of each other. The connection may be any of the aforementioned connections.

However, the actual range of the connection may depend on the levels of interference within the proximity of the electronic device 101 and the mobile phone 102. Accordingly, it could prove difficult to specify a precise, predetermined distance between the electronic device 101 and the mobile phone 102, within which the electronic device 101 has unrestricted functionality, using such a system.

In order to provide more accurate distance limitations when implementing the above outlined functionality (i.e. limitations ranging between 1 to 2 metres), GPS functionality may be provided on the mobile phone 102 and the electronic device 101.

The distance between the electronic device 101 and mobile phone 102 may also be accurately measured where there is a line of sight between the devices using infrared transmitters and receivers.

As has already been mentioned, in one embodiment, in which the electronic device 101 includes an SE, the electronic device 101 may be configured such that it is capable of performing transactions without an established communications link with the mobile phone 102. The electronic device 101 is capable of receiving and storing the data required to perform transactions e.g. account and payment card information. Accordingly, once this data is received and stored, the electronic device 101 is capable of performing transactions.

Such functionality provides significant practical advantages. The user 103 does not need to ensure that a communications link is established between the electronic device 101 and the mobile phone 102 in order to perform a transaction using the electronic device 101.

Transaction counters may be implemented on the electronic device 101 to limit the number of individual transactions and/or the total value of transactions which can be performed by the electronic device 101 before a communications link needs to be re-established. This provides many added security benefits; for example, it limits the use of stolen electronic devices.

The electronic device 101 may comprise part of a wearable device such as a watch, bracelet or necklace. Rather than removing a card from a wallet or a mobile phone from a pocket or a bag, the user of the electronic device 101 of the present invention is able to simply tap, for example, their wrist against a terminal 106 in order to make a payment.

There are significant advantages over current payment watches and other such wearable payment devices available which incorporate a standalone SE with passive RFID functionalities. By virtue of the pairing, the electronic device 101 of the present invention can incorporate all of the functionality of the mobile phone 102 to which it is paired. Card details may be updated and counters may be reset wirelessly via a mobile network 105. For example, if a card is lost or stolen, the issuer 104 may simply provision replacement card details to the mobile phone 102 and the application installed thereon via the mobile network 105 and these new details may be uploaded to the electronic device 101. This whole process could be performed in a very short space of time. Especially in comparison to current payment watches which would require the issuer 104 to create, issue and distribute a physical replacement SE.

The electronic device 101 may comprise a transponder, directly linking the transponder to the mobile phone 102. The transponder may be part of an RFID enabled electronic toll collection system such as TollTag™. The electronic device 101, so configured, would enable the direct payment of roadway tolls by enabling the electronic toll collection system with direct payment functionality such as, for example, PayPass™. Such a system would be more convenient and efficient than the postpaid and prepaid customer accounts currently used in open road tolling systems.

The mobile phone 102 may or may not itself be PayPass™ enabled. It need only be capable of connecting to and transferring data to the electronic device 101. As such, the electronic device 101 may be used to enable a mobile phone 102 with PayPass™ functionality. The required connection between the electronic device 101 and the mobile phone 102 may be any of the aforementioned connections.

The mobile phone 102 need not necessarily be a mobile phone. For example, the mobile phone 102 may be a tablet, PDA, laptop or any device with suitable connectivity. For a device to have suitable connectivity, it may not necessarily be required to have a means for communicating with an issuer 104 via a mobile network 105. For example, the mobile network 105 may instead be the internet or any suitable means for the long-range communication of data between the mobile phone 102 and the issuer 104.

There may be a service provider acting on behalf of the issuer 104, or acting as an intermediary. The service provider may provide and manage the long-range communication means.

None of the embodiments described herein are limited specifically to a mobile phone 102 connected to a mobile network 105.

The electronic device 101 would typically be provided to a user ‘blank’ without any account and payment card information stored on it. As a result, the electronic devices 101 can be distributed through distribution channels other than the financial institutions associated with account holders (e.g. watch retailers, supermarkets etc.). The electronic device 101 as distributed does not contain any account or card details and is not capable of making payments until said details have been uploaded to it.

Alternatively, the electronic device 101 may be provided to a user 103 formatted with a template including blank fields corresponding to the account and card details required in a transaction, the template being ready for completion with the user's details.

The electronic device 101 may be personalised by a user 103 before first use, as described in detail below, in order to enable transactions to be made.

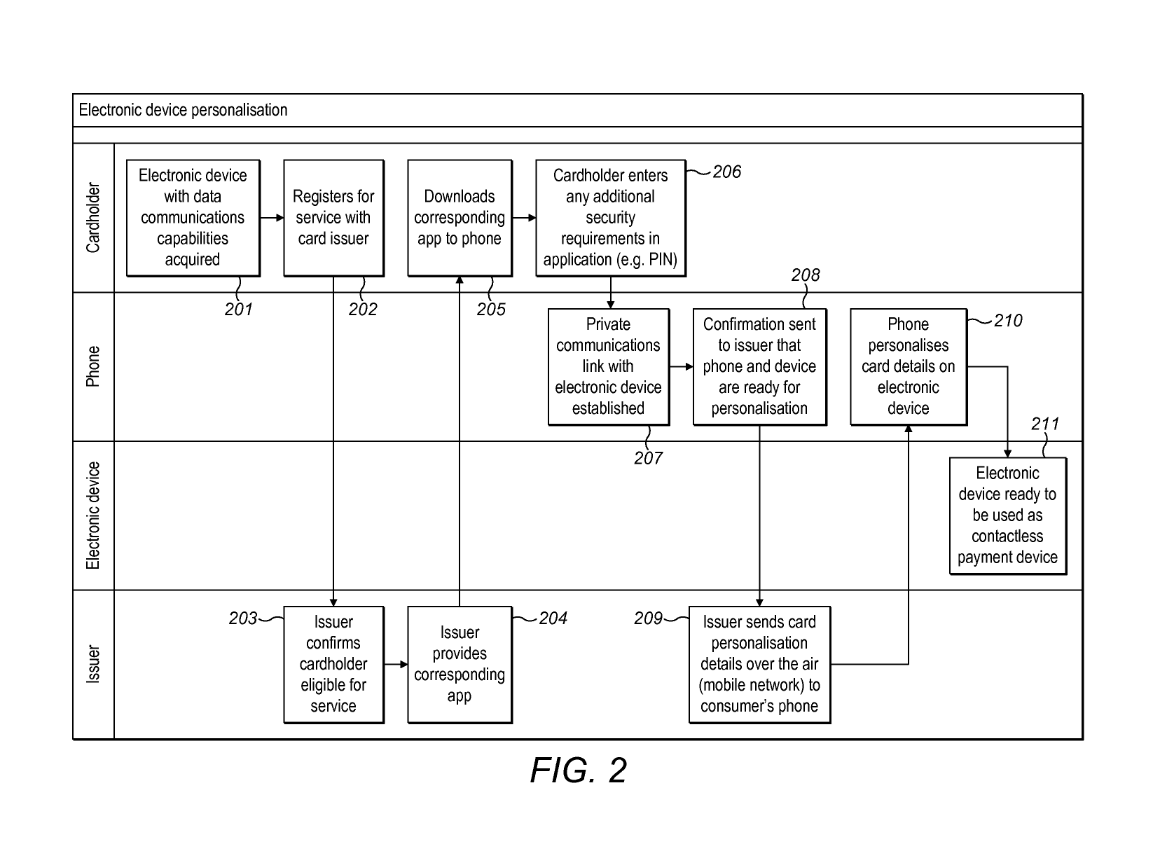

FIG. 2 depicts a flow diagram of the processes which typically occur when a user 103 acquires and subsequently registers and personalises the user's own electronic device 101. After the user 103 has acquired their electronic device 101 (step 201) they register their mobile phone 102 and their account with a contactless mobile payment service associated with the entity (usually a bank or financial institution, henceforth known as the issuer 104) with which they hold an account (step 202). The issuer 104 then verifies that the account and the mobile phone 102 both belong to the user 103 (step not shown).

In order for the issuer 104 to verify the mobile phone 102, the issuer 104 may cross-reference identification information provided by the phone (for example, serial number, IMEI etc.) with third party databases, for example, a database of the third party mobile phone 102 service provider.

Once the registration has been completed and the issuer 104 has confirmed their eligibility for the service (step 203), the issuer 104 provides the user 103 with an application (step 204) which the user 103 then downloads to their mobile phone 102 (step 205).

The application may also be available for the user 103 to download prior to registration. The user 103 may be able to register their mobile phone 102 and their account with a contactless mobile payment service within the application. The user 103 may also be able to register using existing online banking services.

The application requests that the user 103 enter security details (e.g. PIN, answer to a security question or any security details commonly requested in the field of retail banking to verify the user as the account holder) (step 206).

When the security check has been completed, a secure, private communications link is established between the mobile phone 102 and the electronic device 101 (step 207). This link may be a Bluetooth™ or any other suitable connection (e.g. infra-red Wireless, Induction Wireless, NFC, WLAN or Ultra Wideband transceiver).

The mobile phone 102 then sends SE identification information to the issuer 104 (step not shown). In embodiments where the SE is located on the mobile phone 102, this step may be performed prior to step 207. The issuer 104 then checks whether there is a relationship between the user 103 and the SE. If there is a relationship, the issuer 104 then accesses a Secure Element Issuer Trusted Service Manager (SEI TSM) which provides the issuer 104 with the public/private keys for the SE that will enable secure communications, under the key encryption.

Confirmation is then sent to the issuer 104 that the electronic device 101 and mobile phone 102 are ready for personalisation (step 208). The issuer 104 then sends card personalisation details to the user's mobile phone 102 (step 209). The card personalisation details may be sent via a mobile network 105, via a WLAN connection or via a computer connected to the internet where the phone has been connected to a computer, for example, by a USB cable or Bluetooth™ connection.

The user's mobile phone 102 then uploads the card personalisation details to the electronic device 101 via the private communications link which has been established between the two devices, personalising the electronic device 101 (step 210). The card personalisation details may fill the blank template fields, where the electronic device 101 has been provisioned with a template, or the card personalisation details may simply be uploaded to a blank electronic device 101. Subsequently, the electronic device 101 is ready to be used as a contactless payment device.

The user 103 may be able to change or update the uploaded card personalisation details. This may be achieved by repeating steps 206 to 211 with the issuer 104 sending new or updated card personalisation details to the mobile phone 102 at step 209. This allows the electronic device 101 to be reused when a user's card expires or when a user changes issuer 104.

The user 103 may also be able to erase all card personalisation details uploaded on the electronic device 101 and/or restore the original template where such a template has been provided. This allows the electronic device 101 to be used by another person.

At the start of a transaction, an electronic cash register sends details of a transaction to a PayPass™ or similarly enabled POS terminal 106. The appropriately configured electronic device 101 is placed or tapped against the terminal 106. The terminal 106 activates and establishes a communication with the RFID or NFC circuitry in the electronic device 101 which then securely transmits payment account details to the terminal 106. The account and transaction details are then processed through a payment processing network 107.

Where a PIN is required, for example, when a transaction is above a pre-determined threshold, the PIN may be input via a user interface of the electronic device. Alternatively, or additionally, where an electronic device 101 is paired to a mobile phone 102 during a transaction process, the PIN may be entered via a user interface of the mobile phone 102.

The PIN entry step may be performed in advance of the electronic device 101 being placed or tapped against the POS terminal 106 in anticipation of a PIN requirement. Alternatively, the PIN entry step may be performed on request. Following the first placement or tap, a PIN may be requested and subsequently entered using a UI of the electronic device 101. The electronic device 101 is then once more placed or tapped against the POS terminal 106 to continue with the transaction. Again, where an electronic device 101 is paired to a mobile phone 102 during a transaction process, the PIN may be entered via a user interface of the mobile phone 102.

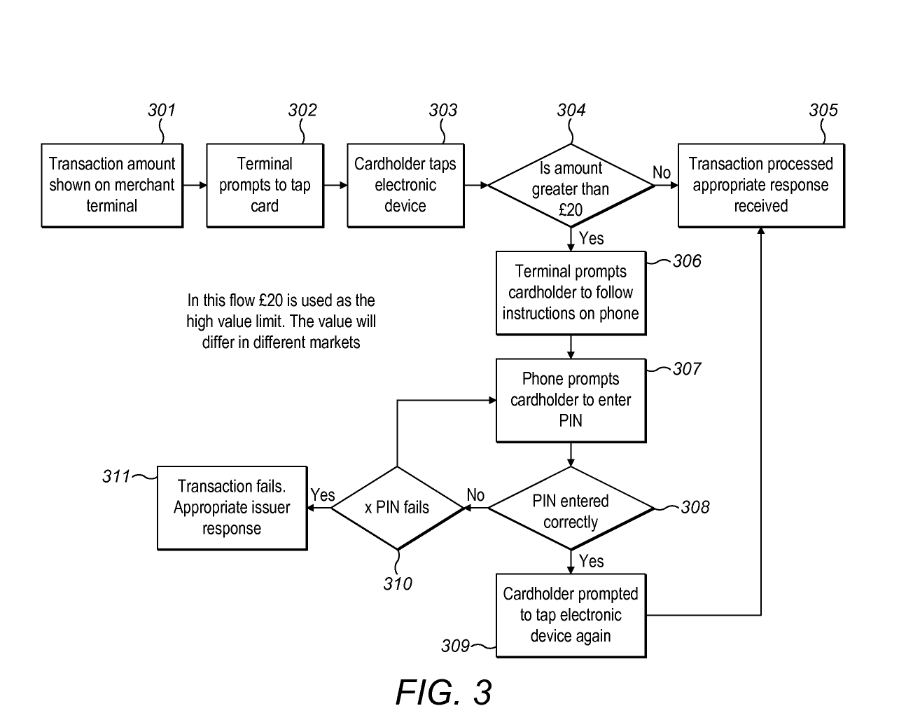

FIG. 3 depicts a flow diagram of the processes which typically occur during a payment transaction performed using the electronic device 101 of the present invention.

A transaction amount is shown on a merchant's terminal 106 (step 301). The user 103 is then prompted to tap their card at the terminal 106 (step 302). The user 103 then taps their electronic device 101 at the terminal 106 (step 303). The terminal 106 determines whether the transaction amount is greater or less than a threshold amount, which in this instance is £20 (step 304). If the transaction amount is less than £20, the transaction is approved and processed (step 305). If the transaction is greater than £20, the terminal 106 prompts the user 103 to follow instructions on their electronic device 101, their mobile phone 102 or, alternatively, the terminal provides further instructions (step 306). The amount need not be £20; any pre-determined amount deemed suitable may be used.

Where the merchant terminal 106 and electronic device 101 support offline PIN verification and the terminal 106, electronic device 101 and/or mobile phone 102 have indicated that a PIN is required to complete the transaction, the payment terminal 106, electronic device 101 and/or mobile phone 102 then prompts the user 103 to enter their PIN either at the merchant terminal 106, e.g. via a keypad on the merchant terminal 106, or at the electronic device 101 and/or mobile phone 102 (step 307).

If, during such an offline transaction, the PIN is entered at the terminal 106, the terminal 106 then prompts the user 103 to tap the electronic device 101 at the terminal 106 to verify whether the PIN is correct (step 309). The terminal needs access to the secure element associated with electronic device 101 in order to verify the PIN entered at the terminal.

Alternatively, if the PIN is entered at the electronic device 101 or mobile phone 102, the user 103 is prompted to tap the electronic device 101 at the terminal 106 again to transmit the result of the PIN verification to the terminal 106 (step 309).

In either scenario, if the PIN is correct the terminal 106 can either approve the transaction or send the details to the Issuer 104 for further approval (step 305).

Where the merchant terminal 106 and electronic device 101 support online PIN verification and the terminal 106, electronic device 101 and/or mobile phone 102 have indicated that a PIN is required to complete the transaction, the payment terminal 106, electronic device 101 and/or mobile phone 102 then prompts the user 103 to enter their PIN at the merchant terminal 106, e.g. via a keypad on the merchant terminal 106 (step 307).

The User 103 then enters their PIN at the merchant terminal 106 and the merchant terminal 106 may send the PIN, transaction details and card details to the issuer 104 for verification. The information may be transmitted via the payment processing network 107. The second tap at step 309 is not required in this scenario.

Alternatively, the payment terminal 106, electronic device 101 and/or mobile phone 102 may prompt the user 103 to enter their PIN either at the electronic device 101 and/or mobile phone 102 (step 307). The user 103 then enters their PIN at the electronic device 101 or mobile phone 102, and a second tap of the electronic device 101 to the terminal 106 is required to transmit the entered PIN details to the terminal 106 which then transmits the PIN, transaction details and card details to the issuer 104 (step 309). Again, the information may be transmitted to the issuer 104 via the payment processing network 107.

In both online PIN scenarios, the issuer 104 then verifies whether a transaction should be allowed, e.g. by checking the account has enough funds and that the PIN is correct. The issuer 104 then sends back an appropriate response to the terminal 106 either declining or approving the transaction (step 305). Importantly, the user 103 is able to perform each of the above outlined transaction processes without use of the mobile phone 102 as the user 101 is able to use electronic device 101 in place of mobile phone 102.

The electronic device 101 may be configured such that after the correct PIN has been entered, where a second tap is required, and the user 103 must tap the electronic device 101 against the terminal 106 within a predetermined period of time (e.g. 60 seconds). Should this period of time be exceeded, the transaction may be cancelled or the user 103 may be required to re-enter the PIN.

If the PIN is incorrect, the mobile phone 102 or electronic device 101 determines whether x incorrect PIN entries have been made (step 310) and if the number of incorrect PIN entries is below the integer x, the user 103 is again prompted to enter a PIN at the mobile phone 102 or electronic device 101 (step 307). If x number of incorrect PIN entries is reached, the transaction fails and an appropriate issuer response is initiated (step 311). For example, the payment functionality of the electronic device 101 and mobile phone 102 may be blocked, the card and application may be disabled or the user's account with the issuer may be closed.

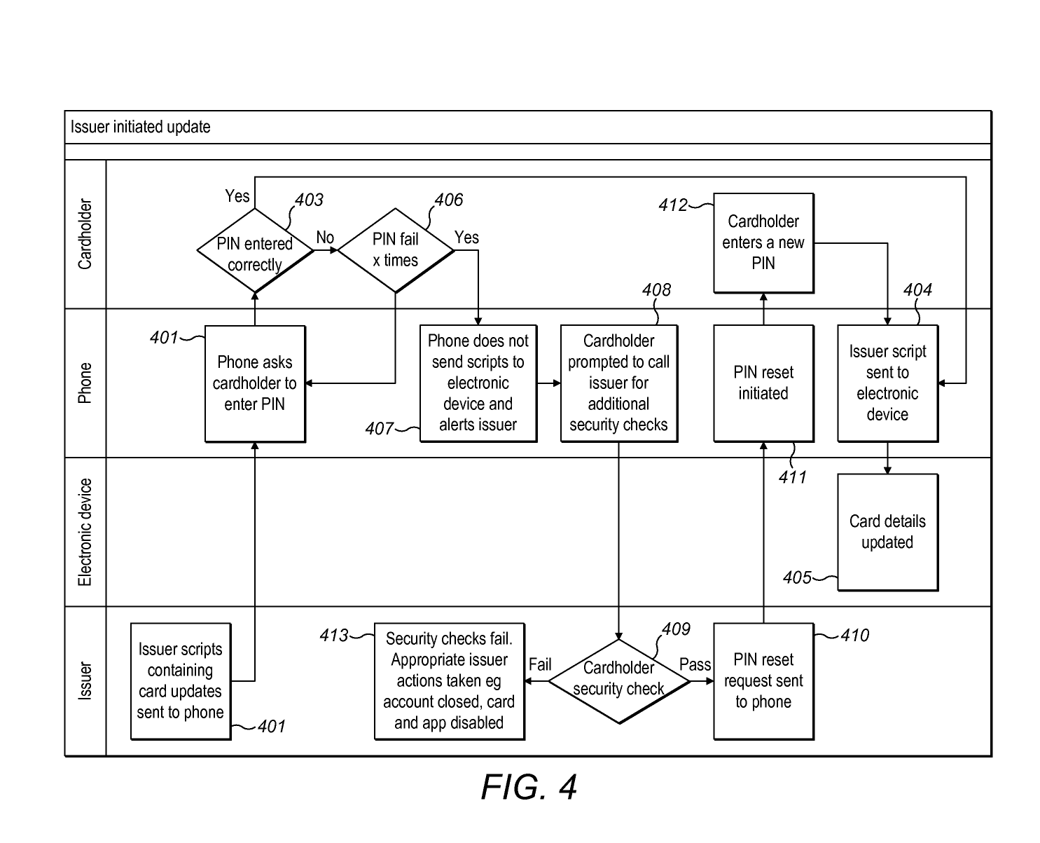

FIG. 4 depicts a flow diagram of the processes which typically occur during an issuer initiated card update. Such updates may occur when an issuer 104 issues a user 103 with new payment card details. Issuer scripts containing the card update are sent to the mobile phone 102 (step 401). The issuer scripts may be sent via a mobile network 105. The mobile phone 102 requests a user 103 to enter a PIN (step 402) which can be input either via the mobile phone 103 or the electronic device 102. The mobile phone 102 determines whether the entered PIN is correct (step 403) and informs the terminal 106 that a PIN has been entered and verified via the electronic device 101.

If the correct PIN has been entered, the mobile phone 102 transmits the issuer script to the electronic device 101 (step 404) and the card details on the electronic device 101 are subsequently updated (step 405).

If an incorrect PIN is entered, the mobile phone 102 or electronic device 101 determines whether x incorrect PIN entries have been made (step 406) and if the number of incorrect PIN entries is below the integer x, the user 103 is again prompted to enter a PIN at the mobile phone 102 or electronic device 101 (step 402). If x number of incorrect PIN entries is reached, the mobile phone 102 does not send the issuer scripts to the electronic device 101 and alerts the issuer 104 of the situation (step 407).

The user 103 is then prompted to contact the issuer 104 in order to complete additional security checks (408). The user may be notified via the display on the mobile phone 102 or via a display on the electronic device 101 (if applicable).

Additional security checks are then carried out (step 409) and if they are successful, a PIN reset request is sent to the mobile phone 102 (step 410) and a PIN reset is initiated (step 411). The user 103 then enters a new PIN (step 412) and the issuer scripts are subsequently sent to the electronic device (step 404) and the card details on the electronic device are updated (step 405).

If the security check fails, the appropriate issuer actions are taken (step 409). For example, the payment functionality of the electronic device 101 and mobile phone 102 may be blocked, the card and application may be disabled or the user's account with the issuer may be closed.

It is possible to enable the electronic device 101 to make a predetermined number of payments without being in communication with the mobile phone 102.

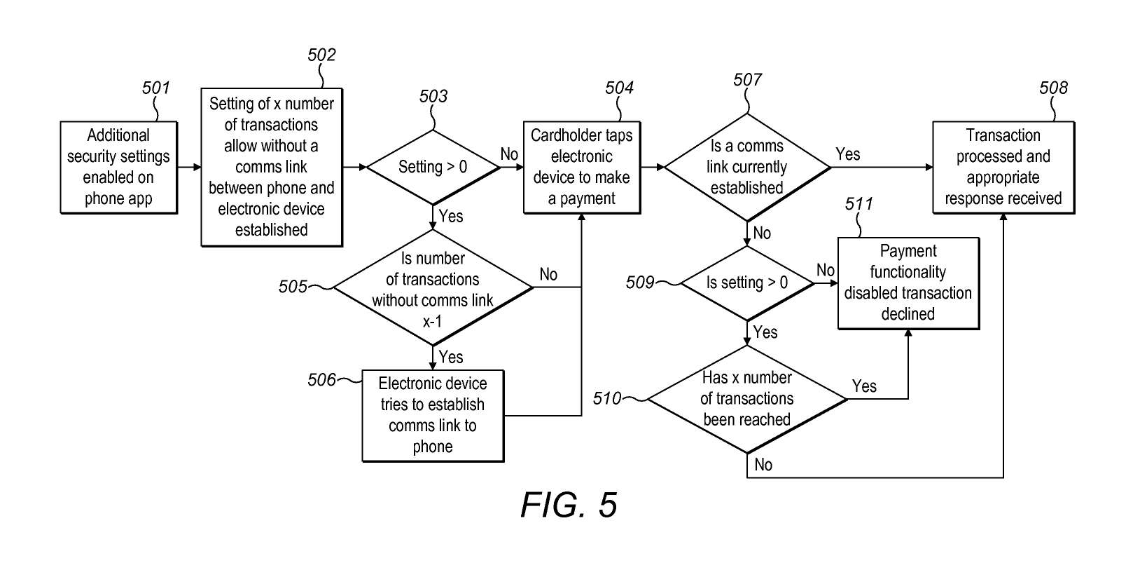

FIG. 5 depicts a flow diagram of the processes which typically occur when setting a limit for the number transactions which the electronic device 101 can perform without an established communications link with the mobile phone 102 and how the transactions subsequently proceed.

The additional security settings relating to limiting the number transactions which the electronic device 101 can perform without an established communications link with the mobile phone 102 are enabled on the issuer application installed on the mobile phone 102 (step 501). This action may be performed by the issuer 104 or the user 103. It may be the case that only the issuer 104 has control over these security features and is able to enable and set them remotely via the mobile network 105.

The number of transactions allowed without a communications link between the electronic device 101 and the mobile phone 102 being established (hereafter called the limit) is then set. (step 502). The electronic device then establishes whether the limit has been set to a value greater than zero (step 503). If limit is not greater than zero, the payment process continues and the user 103 taps the electronic device 101 at the merchant terminal 106 to make a payment (step 504). If limit is greater than zero, the payment device establishes whether the limit imposed in step 501 has been reached (step 505). If the transaction limit has been reached, the payment device 101 attempts to establish a communication link with the mobile phone 102 (step 506) and subsequently the user 103 taps the electronic device 101 at the merchant terminal 106 to make a payment (step 504). If the transaction limit has not been reached, the payment process continues and the user 103 taps the electronic device 101 at the merchant terminal 106 to make a payment (step 504).

When the cardholder taps the electronic device 101 at the merchant terminal 106, the electronic device 101 determines whether a communications link between itself and the mobile phone 102 is currently established (step 507). If an established link is found, the transaction is processed (step 508). If, however, an established link is not found, the electronic device determines whether the limit has been set to a value greater than zero (step 509). If the limit is not greater than zero, the payment functionality of the electronic device 101 is disabled and the transaction is declined (step 511). If the limit is greater than zero, the payment device establishes whether the limit imposed in step 501 has been reached (step 509). If the limit has been reached, the payment functionality of the electronic device 101 is disabled and the transaction is declined (step 511). If the limit has not been reached, the transaction is processed (step 508).

Chips can store an amount of transaction data and use these as counters to determine offline risk management. Counters can only be reset by an issuer when a device is in communication with the Issuer's network using either an over the air mobile network or the existing payment network using a contact interface, for example, by inserting a payment card into a terminal.

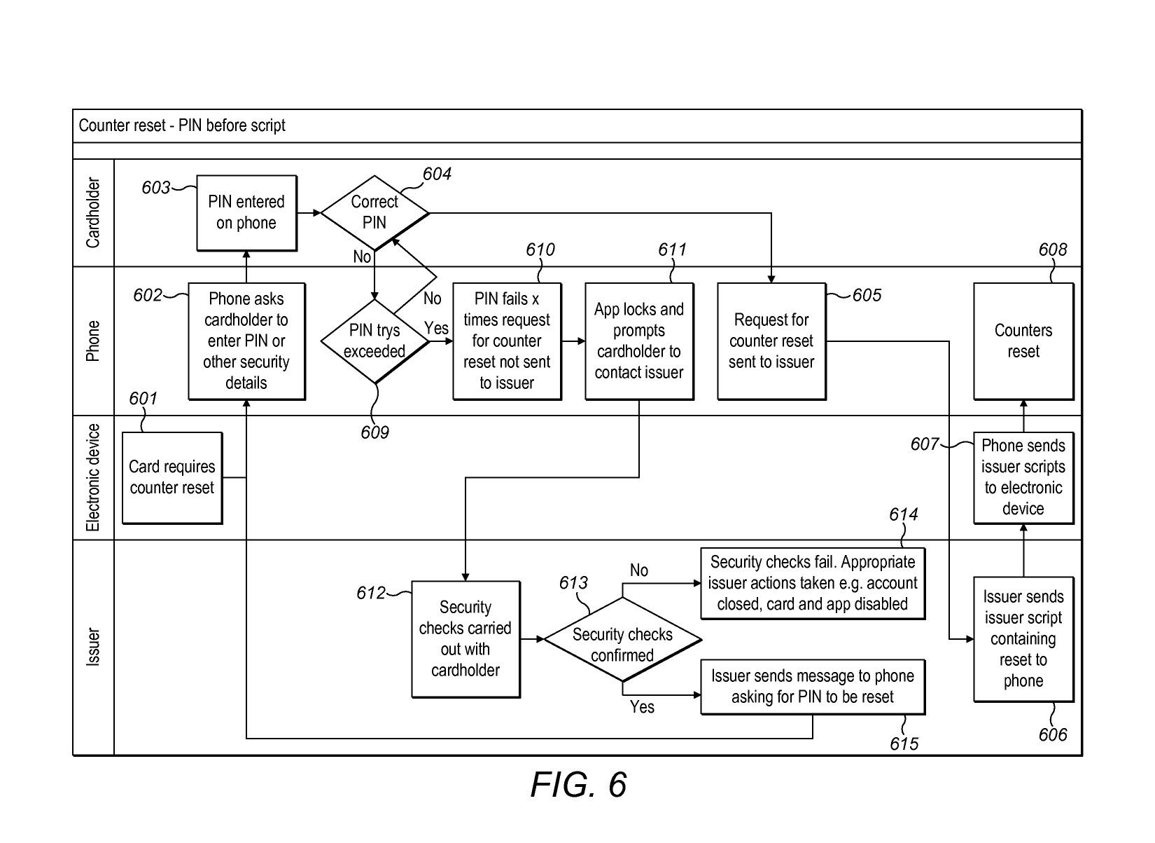

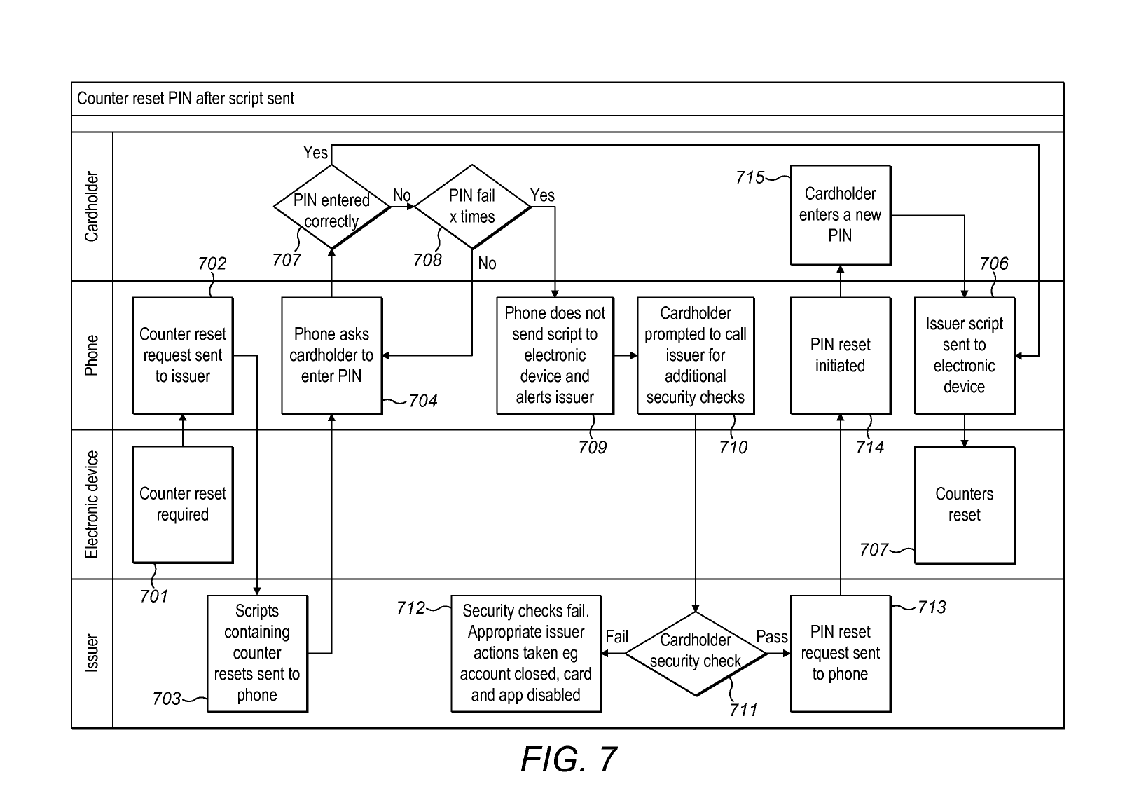

FIGS. 6 and 7 depict flow diagrams of the processes which occur when the counters on the payment card embodied by the electronic device 101 and the mobile phone 102 are required to be reset. This may be required, for example, where the number of transactions performed without the electronic device 101 being in communication with the mobile phone 102 has reached the predetermined limit established by the process illustrated in FIG. 5.

FIG. 6 depicts a situation where a PIN is required in advance of an issuer script containing the counter reset data being sent to the mobile phone 102 by the issuer 104. If a card requires a counter reset (step 601), the mobile phone 102 requests a PIN from the user 103 and/or other security details (step 602). The user 103 then enters the PIN on the mobile phone 102 (step 603). The phone then determines whether the correct PIN has been entered (step 604).

If the correct PIN has been entered, a request for a counter reset is sent to the issuer 104 by the mobile phone (step 605). The request may be sent via a mobile network 105. The issuer 104 then sends an issuer script containing the counter reset data to the mobile phone 102 (step 606). The phone then forwards the issuer script to the electronic device 101 (step 607) and the counters are subsequently reset (step 608).

If an incorrect PIN has been entered, the mobile phone 102 determines whether x incorrect PIN entries have been made (step 609) and if the number of incorrect PIN entries is below the integer x, the user 103 is again prompted to enter a PIN at the mobile phone 102 or electronic device 101 (step 604).

If x number of incorrect PIN entries is reached, a request for counter resetting is not made by the mobile phone 102 (step 610). Subsequently, the card and application may be locked and the user 103 is prompted to call or contact the issuer 104 (step 612) in order to complete additional security checks (step 612). The mobile phone 102 then establishes whether the security checks have been carried out successfully (step 613).

If the security checks failed, then the appropriate issuer actions are taken e.g. the user's account may be closed or the card details and application on the electronic device 101 and mobile phone 102 may be disabled (step 614). If the security checks were successful, the issuer 104 sends a message to the mobile phone 102 requesting that the PIN be reset (step 615) and a PIN reset is initiated. After the PIN has successfully been reset, the mobile phone 102 then asks the user 103 to enter the new PIN and the process begins again from step 602.

FIG. 7 depicts an alternative embodiment, where a PIN is required after an issuer script containing the counter reset data is sent to the mobile phone 102 by the issuer 104. If a card requires a counter reset (step 701), a counter reset request is sent to the issuer 104 by the mobile phone 102 (step 702). An issuer script containing the counter reset data is then sent to the mobile phone 102 (step 703). The mobile phone then requests a PIN from the user 103 (step 704) and/or other security details. The user 103 enters the PIN on the mobile phone 102 and the phone then determines whether the correct PIN has been entered (step 705).

If the correct PIN has been entered, the mobile phone 102 then sends the issuer script to the electronic device 101 (step 706) and the counters are subsequently reset (step 707).

If an incorrect PIN has been entered, the mobile phone 102 determines whether x incorrect PIN entries have been made (step 708) and if the number of incorrect PIN entries is below the integer x, the user 103 is again prompted to enter a PIN at the mobile phone 102 (step 704).

If x number of incorrect PIN entries is reached, the mobile phone 102 does not send the issuer script to the electronic device 101 (step 709). Subsequently, the card and application may be locked and the user 103 is prompted to call or contact the issuer 104 (step 710) in order to complete additional security checks (step 711).

If the security checks fail, then the appropriate issuer actions are taken e.g. the user's account may be closed or the card details and application on the electronic device 101 and mobile phone 102 may be disabled (step 712).

If the security checks are successful, the issuer 104 sends a message to the mobile phone 102 requesting that the PIN be reset (step 713) and a PIN reset is initiated (step 714). The user 103 is prompted to provide a new PIN (step 715). After the PIN has successfully been reset, the mobile phone 102 then asks the user 103 to enter the new PIN (step 715). If the PIN is correct the issuer script is sent to the electronic device 101 (step 706) and the counters are reset (step 707). If the PIN is incorrect, step 704 is repeated.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. An electronic device for use in a transaction process, the electronic device comprising:
a first wireless communication module for communicating with a second electronic device;
a second wireless communication module for communicating with a payment terminal for the purpose of performing a payment transaction
wherein the electronic device is capable of relaying data between the second electronic device and the payment terminal.

2. The electronic device of claim 1, wherein:
the first wireless communication module comprises one of an NFC or RFID transmitter or transceiver; and
the second wireless communication module comprises one of a Bluetooth, infra-red Wireless, Induction Wireless, second NFC, WLAN or Ultra Wideband transmitter or transceiver.

3. The electronic device of claim 2, wherein the electronic device is configured to wirelessly communicate with the second electronic device via the Bluetooth transmitter or transceiver and is further configured to wirelessly communicate with the payment terminal via the NFC or RFID transmitter or receiver.

4. The electronic device of claim 3, wherein a Bluetooth connection with the second electronic device is a secure, private communications link.

5. The electronic device of claim 1, wherein the electronic device comprises at least part of a wearable device such as a wristwatch, pendant or bracelet.

6. The electronic device of claim 1, wherein the second electronic device is a mobile phone arranged to be in communication with a remote server via a mobile network or Wi-Fi connection.

7. The electronic device of claim 6, wherein the mobile phone is in communication with an issuer server via the mobile network.

8. The electronic device of claim 1, further comprising a user interface.

9. A transaction processing system comprising:
an electronic device comprising a first wireless communication module and a second wireless communication module;
a second electronic device in communication with the electronic device using the first wireless communication module;
a payment terminal in communication with the electronic device using the second wireless communication module; and
wherein the electronic device is in communication with the payment terminal and the second electronic device, and facilitates the transfer of data between the payment terminal and the second electronic device.

10. The transaction processing system of claim 9, further comprising:
a communications network; and
an issuer server,
wherein the second electronic device is in communication with the issuer server via the communications network.

11. The transaction processing system of claim 10, wherein the second electronic device is a mobile phone and the communications network is a mobile network.

12. A method of performing a transaction, said method comprising the steps of:
establishing a first wireless communication between an electronic device and a second electronic device;
uploading transaction details required to perform a contactless transaction from the second electronic device to the electronic device and securely storing them on the electronic device;
establishing a second wireless communication between the electronic device and a payment terminal; and
providing the payment terminal with the transaction details.

13. The method of claim 12 wherein the step of establishing a first wireless communication between the electronic device and the second electronic device comprises establishing a secure, private communications link.

14. The method of claim 13, wherein the private communications link is one of a Bluetooth, infra-red Wireless, Induction Wireless, NFC, WLAN or Ultra Wideband connection.

15. The method of claim 12, wherein the transaction details comprise payment card details.

16. The method of claim 12, wherein the step of establishing a second wireless communication between the electronic device and the payment terminal comprises establishing an NFC or RFID connection.

17. The method of claim 12, wherein the payment terminal can only be provided with the transaction details when the electronic device is located within a predetermined distance of the second electronic device.

18. An electronic device, comprising:
A memory storing computer-executable program code; and
A processor to execute the processor-executable program code in order to cause the electronic device to:
establish a first wireless communication with a second electronic device;
receive transaction details required to perform a contactless transaction from the second electronic device and securely store them on the electronic device;
establish a second wireless communication with a payment terminal; and
provide the payment terminal with the transaction details.
